(19) United States
(12) Patent Application Publication
(10) Pub. No.: US 2016/0355426 A1
(43) Pub. Date: Dec. 8, 2016

(54) MICROWAVE PROCESSING OF WASTEWATER SLUDGE

(71) Applicant: GENERAL ELECTRIC COMPANY, Schenectady, NY (US)

(72) Inventors: Vasile Bogdan Neculaes, Niskayuna, NY (US); Stephen Robert Vasconcellos, Doylestown, PA (US); Brian Christopher Moore, Mechanicville, NY (US); Anthony John Murray, Lebanon, NJ (US); June Klimash, Baton Rouge, LA (US); Kenneth Roger Conway, Clifton Park, NY (US); Tracy Lynn Paxon, Waterford, NY (US); Michael Brian Salerno, Huntingdon Valley, PA (US); Casey L. Renko, Troy, NY (US)

(21) Appl. No.: 15/244,075

(22) Filed: Aug. 23, 2016

Related U.S. Application Data
(63) Continuation-in-part of application No. 13/332,914, filed on Dec. 21, 2011, now abandoned.

(51) Int. Cl. C02F 11/12; C02F 3/34; C02F 1/30

(52) U.S. Cl. CPC C02F 11/12; C02F 1/302; C02F 11/123; C02F 3/342; C02F 11/122; C02F 1/42

(57) ABSTRACT

Methods for treatment of sludge with microwave irradiation for improving its dewatering are provided. In one embodiment, the method includes exposing the sludge to microwave irradiation at an absorbed power density of between about 7 W/ml and about 13 W/ml. Turbidity, total solids content and overall dewaterability are improved when the microwave irradiation treatment is combined with another method for dewatering sludge, such as enzyme treatment, conditioning with a flocculating agent and mechanical dewatering.

### CROSS REFERENCE TO RELATED APPLICATION

This application is a Continuation-In-Part (CIP) Application of commonly assigned, U.S. patent application Ser. No. 13/332914, entitled “MICROWAVE PROCESSING OF WASTEWATER SLUDGE” (attorney docket no. 249498-1), filed on Dec. 21, 2011, the contents of which are hereby incorporated by reference in their entirety.

### BACKGROUND

The subject matter disclosed herein relates generally to treating wastewater sludge, and in one aspect, to improving the efficiency of dewatering of the sludge.

As landfill space becomes increasingly limited and fuel costs rise, the cost of sludge disposal in a landfill or by incineration continues to increase, making more effective dewatering of wastewater sludge desirable for wastewater treatment plants (WWTP). An efficient sludge handling system seeks to achieve maximum dewatering with minimum cost.

During the dewatering process, the sludge goes through a number of steps to separate the water from the solid content of the sludge. The sludge may be “conditioned” by mixing with chemical conditioning and/or flocculating agents to effect coagulation of the solids in the sludge and thereby facilitate separation. The solids are mechanically separated from the water using means such as a gravity belt, belt filter press, centrifuge or the like. The dewatering process seeks to increase the solids per unit of sludge and therefore, reduce the amount of sludge to be disposed of in a landfill or by other means.

Even after the dewatering process, however, the sludge cake is mostly composed of water. Visibly, the sludge appears dry, but it contains significant amounts of water that is bound within a gel-like polymeric material that is secreted by bacteria within the sludge and also contained within the bacterial cells themselves. Although it is highly desirable to remove this water, it is difficult to do so.

It is known that water is bound to the sludge by extracellular polymeric substances (EPS), high-molecular weight compounds secreted by microorganisms contained within the sludge into their environment. Proteins and polysaccharides constitute the major components of EPS, which also contains nucleic acids, humic acids, lectins, lipids and other polymers. Estimates found in the literature suggest that EPS and the water bound to it constitute the majority of mass in biofilms and biological sludge, representing a portion of the mass that is larger than the mass of the bacteria themselves. One source claims that EPS typically represents 50-90% of biofilm mass, with the cells representing the remaining 10-50%. Disruption or degradation of the EPS is likely a worthwhile approach to improving the dewatering characteristics of wastewater sludge.

The dewatering of municipal and industrial sludge containing suspended organic solids is typically accomplished by mixing the sludge with one or more chemical agents to induce a state of coagulation or flocculation of the solids, which are then separated from the water using mechanical means

To date, enzymatic, chemical and thermal approaches have been used to facilitate water release from sludge flocs with varying success. Sludge flocs are complex and dynamic aggregates consisting primarily of a matrix of EPS and microorganisms embedded in the matrix, both of which impact the dewatering characteristics of the sludge. Microwave irradiation has also been studied as an approach to improve dewaterability through either degradation of EPS and/or by altering the mechanical and/or chemical integrity of sludge flocs. One of the challenges of sludge solid-liquid separation is to sufficiently disrupt the bonds between the water molecules and the EPS matrix without causing destruction of the microorganisms themselves, which, rather than improving dewatering, can actually lead to an increase in the water content of the sludge.

A need exists to identify improved sludge treatment methods to be used in wastewater processing that will disrupt the water binding capacity and/or the mechanical integrity of the sludge thereby improving dewaterability. The ability to increase cake solids would provide clear financial and operations benefits, including: 1) reduction of dewatered sludge volume for plant handling as well as landfill or application, 2) decrease in hauling costs to remove sludge from WWTP, 3) reducing water to be evaporated through incineration and 4) a more concentrated sludge for secondary treatment in digesters.

### SUMMARY

In one aspect, a wastewater treatment method is provided. The method comprises exposing sludge from a wastewater treatment process or facility to microwave irradiation at an absorbed power density (Watts per milliliter of sludge) of about 3 W/ml to about 17 W/ml, more advantageously at an absorbed power density of about 7 W/ml to about 13 W/ml, even more advantageously, at an absorbed power density of about 10 W/ml. Exposure of sludge to microwave irradiation is for a period of about 1 to about 60 seconds, more advantageously for about 5 to about 50 seconds, and even more advantageously for about 10 to about 30 seconds.

In some embodiments the microwave irradiation is delivered at a frequency in the range of about 0.4 GHz to about 6 GHz and more advantageously, in the range of about 0.915 GHz to about 2.45 GHz.

In another aspect, the method for treatment of sludge comprises combining microwave irradiation treatment with at least one additional method used in the dewatering of sludge including but not limited to: enzyme treatment or treatment with a polyelectrolyte flocculating agent, for example. In some embodiments, the enzyme is amylase.

In another aspect, the method comprises subjecting the sludge to mechanical dewatering, substantially simultaneously with exposure to microwave irradiation.

In yet another aspect, the disclosure relates to a method for dewatering sludge, the method comprising substantially sequentially: a) adding an effective amount of an enzyme composition comprising a glucosidic polysacharide hydrolyzing activity to form an enzyme-treated sludge; and b) exposing the enzyme-treated sludge to microwave irradiation at an absorbed power density of about 3 W/ml to about 17 W/ml. In some embodiments the method further comprises c) exposing the irradiated sludge to mechanical dewatering using methods known to those of skill in the art.

These, and other objects, features and advantages of this disclosure will become apparent from the following detailed description of the various aspects of the disclosure taken in conjunction with the accompanying drawings.

### BRIEF DESCRIPTION OF THE DRAWINGS

FIG. 1 is a graph showing the effects of microwave irradiation on turbidity of sludge.

FIG. 2 is a graph showing the results of a gravity drainage test performed on sludge samples that have been exposed to microwave irradiation.

FIG. 3 shows the results of crown press dewatering of sludge samples that have been exposed to microwave irradiation in comparison to untreated samples.

FIG. 4 shows the results of a comparison of percent total solids in sludge samples following various treatments.

FIG. 5 shows a belt press apparatus for exposing sludge to microwave irradiation while substantially simultaneously squeezing the water from the irradiated sludge.

FIG. 6 shows a belt/filter press apparatus for exposing sludge to microwave irradiation while substantially simultaneously squeezing the water from the irradiated sludge.

FIG. 7 shows a belt press/centrifuge apparatus for exposing sludge to microwave irradiation while substantially simultaneously squeezing the water from the irradiated sludge.

FIG. 8 shows a belt press/centrifuge apparatus for exposing sludge to microwave irradiation while substantially simultaneously squeezing the water from the irradiated sludge.

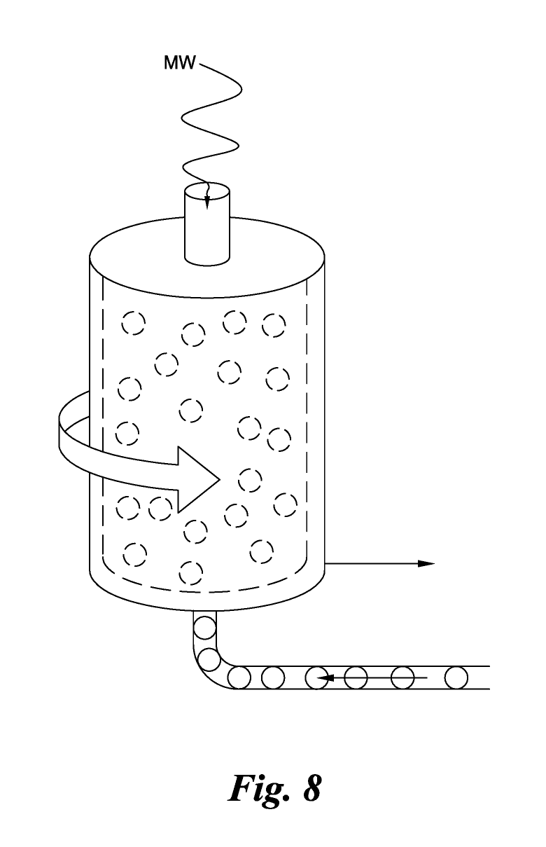

FIG. 9 schematically illustrates the scientific relationship between incident or forwarded power, reflected power and absorbed power, as is commonly understood in microwave technology literature.

### DETAILED DESCRIPTION

The present disclosure relates generally to methods for processing of wastewater sludge. Specifically, the present disclosure relates to a method of improving dewaterability of biological sludges (including, but not limited to HPI sludge) by exposing the sludge to microwave irradiation at an absorbed power density of about 3 W/ml to about 17 W/ml. In one embodiment, microwave irradiation at an absorbed power density of about 7 W/ml to about 13 W/ml is desirable. In yet another embodiment, the absorbed power density of the microwave irradiation to which the sludge is subjected is about 10 W/ml.

The present inventors have shown that microwave irradiation at that level of absorbed power density triggers rapid separation of residual water from the sludge, improving turbidity and dramatically improving the water drainage obtained when sludge is conditioned with a flocculating polymer. Microwave treatment therefore, can initially improve turbidity/flocculation of a sludge and increase settlability. In one embodiment, microwave treatment is temporally combined with mechanical dewatering to take advantage of the enhanced coagulation effect.

Sludge is a complex mixture of water, mineral and organic substances, proteins and polysaccharides (referred to collectively as extracellular polymeric substances or EPS) and microorganisms. Water is retained in the sludge as a result of the complex chemical and electrostatic interactions between the living and inorganic components of the sludge.

EPS concentration and particle size of the sludge are key factors in sludge dewaterability. Initially, increasing concentrations of EPS in the sludge are likely to result in a high degree of flocculation, which would improve dewaterability characteristics. When the optimal flocculation and deflocculation balance is achieved, further increases in EPS concentration only serve to worsen sludge dewaterability.

Studies have shown that the interactions of the very weak electrostatic forces binding EPS components together, which are important to the colloidal stability of sludge flocs, are disrupted during microwave irradiation. However, it has been suggested that microwave irradiation of sludge at certain powers and contact times not only breaks the flocs but also completely destroys cellular components of the sludge, releasing intracellular materials and additional water from the cells into the aqueous phase. One such study found a contact time of 60 seconds at a microwave absorbed power density level of 2.25 W/ml to be optimal for improving sludge dewaterability.

The present inventors have unexpectedly found that sludge dewaterability can be enhanced by exposure of the sludge to microwave irradiation at an absorbed power density and for contact times not previously reported. Additionally, the microwave effect is amplified when combined with other conditioning methods, including but not limited to polyelectrolyte conditioning, enzyme treatment, simultaneous mechanical dewatering or a combination thereof.

Using the method of the disclosure, the dewaterability of biological sludge is enhanced by a relatively short exposure, less than a minute, to microwave irradiation at an absorbed power density in the range of about 3 W/ml to about 17 W/ml, more advantageously about 7 W/ml to about 13 W/ml, even more advantageously about 10 W/ml.

A single exposure to microwave irradiation may be desirable at any stage of the dewatering process. Alternatively, the sludge may be treated with microwave irradiation at multiple points in the process. In one embodiment, microwave irradiation can be applied to settled sludge, which is then sent to dewatering via belt press. As another example, sludge cake coming from a belt press may be fed into the microwave apparatus and subsequently sent to a second dewatering process. One of skill will appreciate that these are non-limiting examples of potential configurations provided for illustrative purposes only.

Microwave irradiation of sludge can be achieved using a commercially available microwave unit with microwave frequencies in the range of about 0.4 GHz to about 6 GHz, or more advantageously in the range of about 0.915 GHz to about 2.45 GHz.

The microwave unit may be used in any configuration that delivers the appropriate dose of irradiation. In some embodiments, modifications to fit a specific application or workflow may be needed. In some instances, it may be desirable to employ an alternate design whereby component materials, contact time and/or microwave power (or other characteristics) is different from traditional units. For instance, if applying microwave concurrently with a pressure-based dewatering process (e.g. filter press or belt press), incorporation of mechanical dewatering means into the microwave unit will be required. Additionally, it may be desirable to utilize a material in components of the press or other mechanical dewatering means that does not absorb microwave, for example, polytetrafluoroethylene.

Microwave irradiation can be continuous wave (the amplitude of the electromagnetic field that the sludge sample sees would vary with the microwave power level) or pulsed. Sludge irradiation can be performed as a continuous process or in batch mode. The power level and the exposure time would be adjusted as a function of sludge properties and the desired end result; some examples of sludge properties include solids content, EPS/cell ratio for biomass, aerobic vs. anaerobic sludge, sludge age, type of wastewater that was treated by the biomass.

Microwave frequency can play an important role in efficiency and depth of penetration into a material. The methods disclosed herein cover microwave frequencies from about 0.4 GHz up to about 6 GHz; frequencies in the range of about 0.915 GHz to about 2.45 GHz may be favorable due to their commercial availability.

### Enzyme Conditioning

Amylases, a group of enzymes, which catalyze hydrolysis of starch and other linear and branched polysaccharides are well known in the art and routinely used in wastewater processing of sludge. Related conditioning agents include other enzyme-based preparations such as powders consisting of waste digesting enzymes and select strains of natural bacteria. When used in a wastewater treatment system, these preparations provide a concentrated source of hydrolytic enzymes and strains of natural bacteria that are capable of producing enzymes in the waste treatment system. Additionally, other enzymes including but not limited to nucleases, proteases, lipases and the like may be useful in altering the chemical interactions which prevent water from being released from sludge.

### Flocculating Agents

Other conditioning methods which may be combined with the microwave treatment of the disclosure include but are not limited to addition of reagents to promote coagulation, flocculation and ion exchange to improve water separation from sludge. Polyelectrolyte flocculants are one example of a reagent used to improve dewaterability of sludge. Many others are known to those of skill in the art.

In some embodiments, determination of the water content of the sludge starting material may be desirable. The amount of water can be determined according to standard methods that are well known in the art to establish a baseline value. Waste sludge is then exposed to microwaves in a frequency range from about 0.4 GHz to about 6 GHz, more conveniently, from about 0.915 GHz to about 2.45 GHz, and an absorbed power density of 3 W/ml to 17 W/ml, for time periods between 1 and 40 seconds.

In one embodiment, sludge is treated with an enzyme composition and then exposed to about 100 W to about 300 W of microwave irradiation for about 1 to about 45 seconds, and more conveniently for about 10 seconds to about 30 seconds. The enzyme composition comprises amylase and at least one additional enzyme, such as a protease, a lipase, or nuclease.

Microwave Irradiation Concurrently with Mechanical Dewatering

In one aspect, microwave irradiation of sludge occurs substantially simultaneously with mechanical dewatering, for example, by compressing the sludge before and/or during and/or after microwave irradiation. A wastewater treatment apparatus for use in practicing the method of the present disclosure will include a chamber in which the sludge is exposed to microwave irradiation at the appropriate power and for the desired time. Additionally, the microwave chamber includes means for dewatering so that water removal occurs substantially simultaneously with microwave treatment.

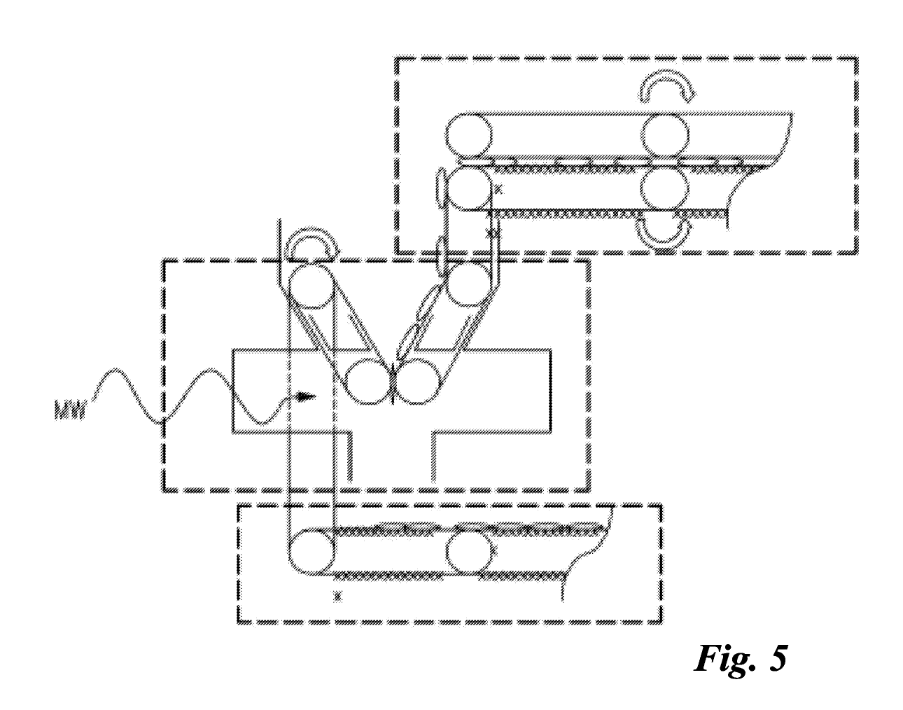

Typically, waste materials are introduced into a processing apparatus by conveyor systems. The waste system, embodiments of which are shown in FIGS. 5 to 7, provides at least one conveyor to move the waste materials to be treated into the microwave chamber. The components of the conveyors typically include a belt, a first roller, and a second roller. For conveyors outside the microwave chamber, the belt may be made from any material that is flexible and resilient. Latex, silicone, polyurethane, rubber, plastic and nylon are examples of materials that may be used in manufacturing the belt.

Rollers of conveyors external to the microwave chamber can be constructed in any manner well known in the pertinent art including, but not limited to, an assembly of any of a disk, axle, roller bearings, and ball bearings.

For conveyors within the microwave chamber, an appropriate adjustment of materials for components of the conveyor is made.

Conveyors can be variable speed conveyor belts with a motor controlled by a controller in which the feed rate of waste materials can be adjusted. A variety of devices known to those of skill in the art other than a conveyor can be utilized to introduce waste materials.

In one embodiment, sludge that is pre-drained through both gravity and pre-stressed belts, which squeeze out water, enters a microwave chamber of the dewatering apparatus where the sludge is exposed to microwave irradiation of about 100 W to about 500 W for approximately 10 to 60 seconds. During irradiation, the sludge is simultaneously squeezed by two rollers. Excess water falls onto the meshed belt below, which provides drainage. Rollers are made from microwave transparent material, as are the belts that enter and exit the chamber. Rollers protrude outwardly on either side of the chamber and are supported as deemed appropriate (see FIG. 5).

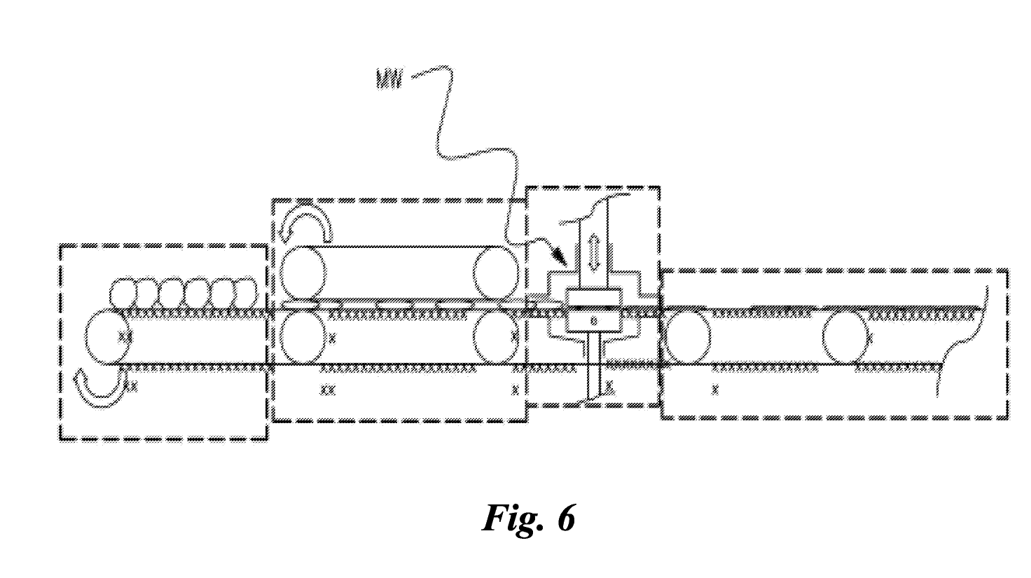

In one embodiment, a waste treatment system provides a conveyor or other means to move the sludge to be treated into a microwave chamber or cavity, where it is irradiated and at the same time compressed, for example, between a piston and a platen. The piston and platen are made from microwave transparent material, as are the belts that enter and exit the chamber (see FIG. 6). Excess water drains through the bottom of the chamber. Pins which connect the platen and its support protrude outward on either side of the chamber. Prior to entry into the microwave chamber, sludge may be pre-drained through gravity and/or pre-stressed belts which squeeze out water. Following irradiation/dewatering, sludge is carried away on a mesh which allows water to continue to drain.

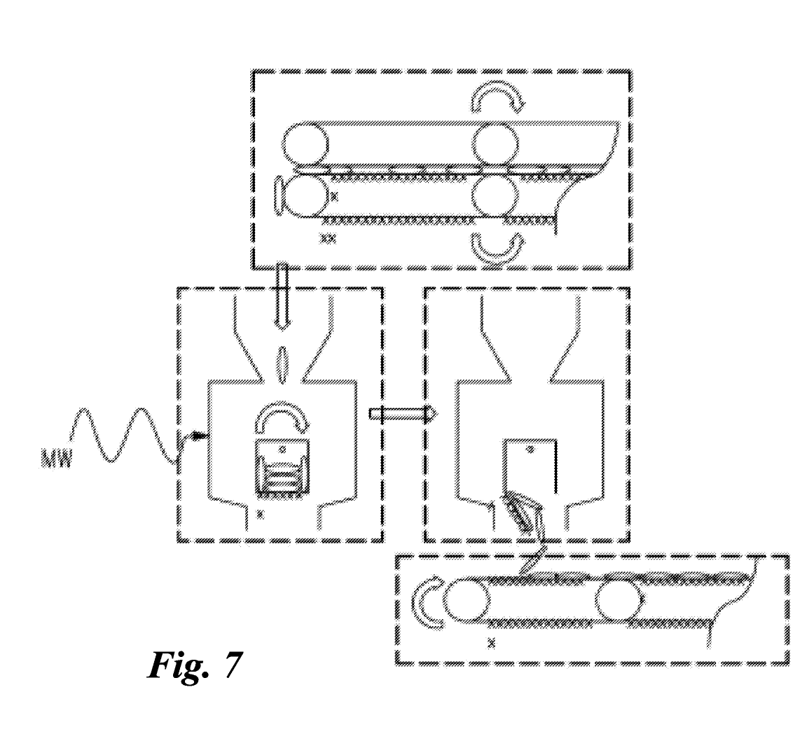

Another embodiment of combined microwave irradiation and dewatering is shown in FIG. 7. As it enters the microwave chamber, the sludge falls into a rotating bucket with a mesh bottom. As the bucket is rotated, water is removed from the sludge and the excess water strikes the chamber walls and then drains onto the meshed belt below, which provides drainage. Both the bucket and the meshed bottom are made from microwave transparent material. The bucket is supported by rods that protrude outwardly on either side of the chamber and are supported and rotated as deemed appropriate.

Most of the prior literature or research relate only to measurement of forward or incident microwave power and not absorbed power, the component of the microwave power physically absorbed by a sample of sludge. For instance, in a typical kitchen microwave oven, it is usually the forward or incident power that is measured but not the absorbed power that actually matters.

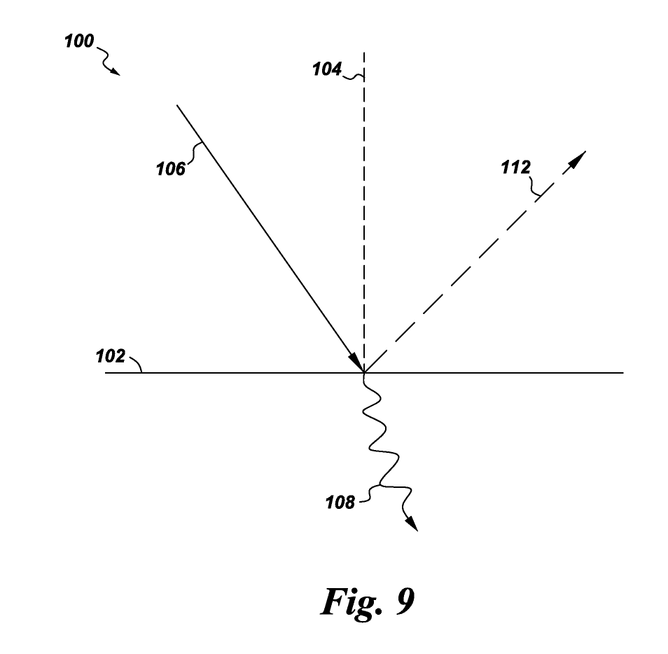

FIG. 9, as a contrast, schematically illustrates the scientific relationship between incident or forwarded power, reflected power and absorbed power, as is commonly known in microwave technology literature. Referring to FIG. 9, microwave phenomenon 100 represents what happens when an incident microwave radiation power, also known as forwarded microwave radiation power 106, is incident on a receiving object 102. One component, 112, of the incident or forwarded power 106 is reflected back to the medium of origin. The reflected component 112 represents that part of the incident energy or power which is not received or utilized by the intended receiving object. The remaining portion, 108, of the incident or forwarded power 106 is typically absorbed by the receiving object. The absorbed power 108 is finally what the object receives and utilizes. It is the objective of any microwave application to maximize the absorbed power component 108 and minimize the reflected power component 112. Dotted line 104 represents an imaginary normal to the surface of the object 102 at the point of incidence of the microwave power rays.

The written description uses the following examples to illustrate the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art.

### EXAMPLE 1

Thirty (30) ml of secondary aerobic sludge was aliquotted into each of several glass test tubes; these samples were then divided into control and treatment groups. A single mode microwave system was used to irradiate the sludge samples at 200-300 W for 10, 20 and 30 seconds. The microwave system used was continuous wave; the power and electric field were adjusted accordingly. Forward power, absorbed power and reflected power were monitored; tuning stubs were used to minimize reflected power and maximize absorbed power. In one embodiment of the invention, the reflected power 112 (FIG. 9) may be adjusted to be “0” (zero), signifying that all of the incident or forwarded power 106 is transferred to the object 102 (the sludge in this example) as absorbed power 108.

During microwave irradiation at 300 W for 20 s and 30 s, the samples reached maximum temperatures of approximately 50-60° C. and 70-80° C., respectively.

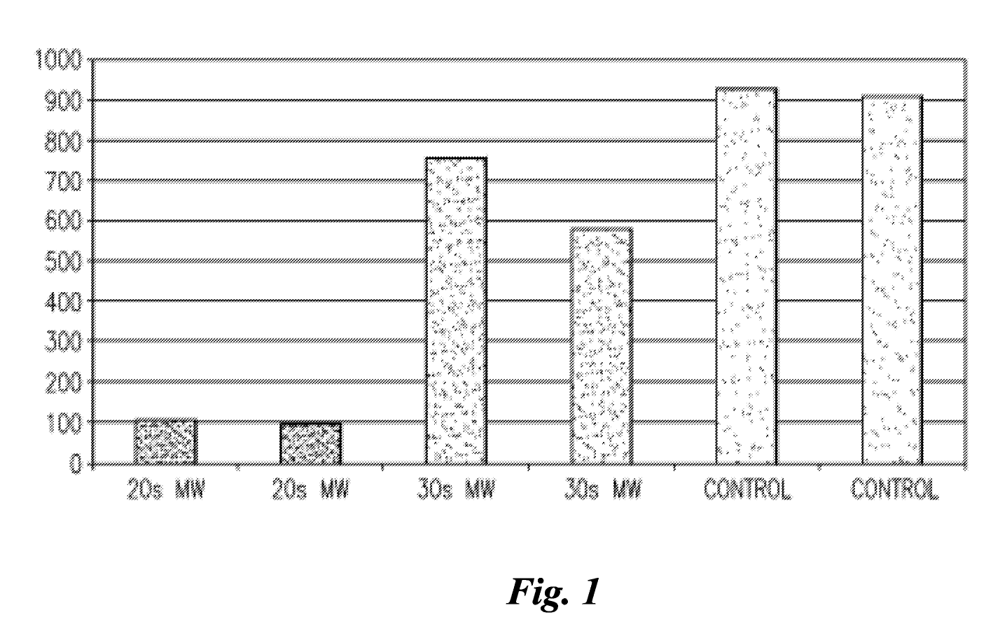

Following irradiation treatment, treated and untreated sludge samples were allowed to settle for 45 seconds. Using standard methodology, the samples were then assessed for turbidity. Exposure of sludge samples of 30 ml to a forwarded power level of 300 W with zero reflected power, amounts to an absorbed power level of 300 W (i.e. absorbed power density of 10 W/ml). This stated level of absorbed power density (10 W/ml), continued for 20 seconds, unexpectedly resulted in a dramatic separation of water from the sludge (Results shown in Table 1 below and FIG. 1).

TABLE 1

| | |
|---|---|
| 20 s MW | 101.7 |
| 20 s MW | 91.34 |
| 30 s MW | 753.3 |
| 30 s MW | 578 |
| Control | 927.1 |
| Control | 906.4 |

### EXAMPLE 2

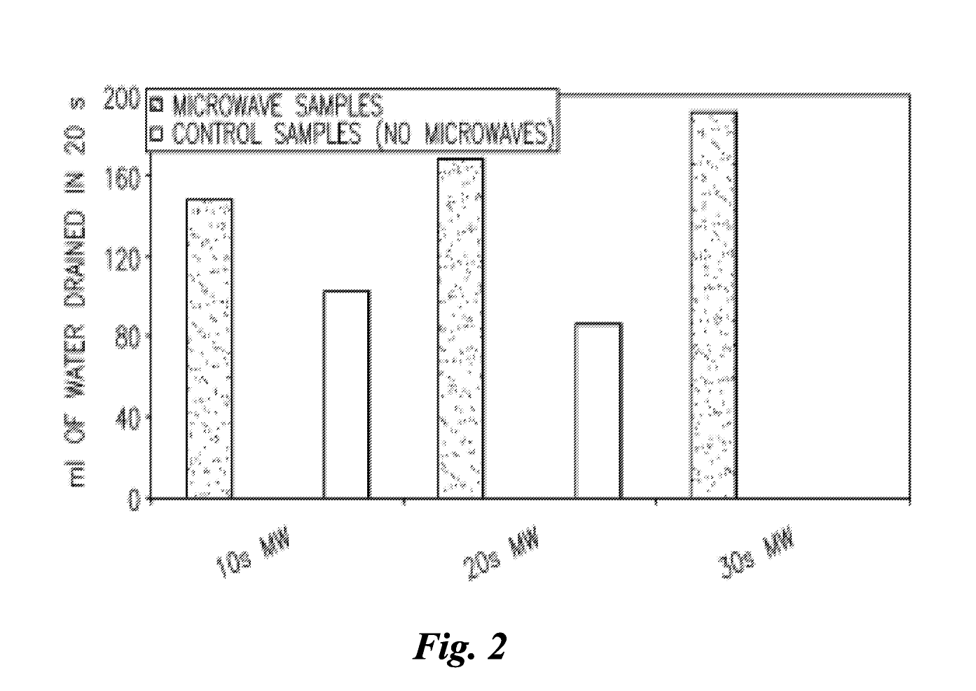

Sludge samples were exposed to microwave irradiation as described in Example 1. Following microwave exposure for 10, 20 or 30 seconds, sludge samples were mixed with a flocculating polymer, CE2694 (GE Water) to achieve a final concentration of 100 ppm. A gravity drainage test was performed in accordance with methods known to those of skill in the art and the amount of water drained in 20 seconds was determined. Compared to control samples that were not exposed to microwaves, the amount of water drained from microwave-exposed samples was increased by 40% or more. The results are shown in FIG. 2.

### EXAMPLE 3

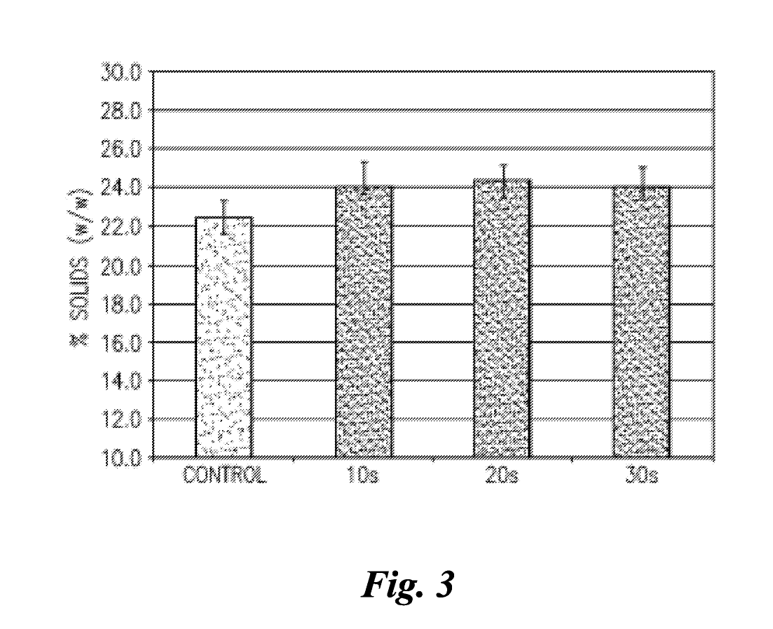

Sludge samples were exposed to microwave irradiation as described in Example 1. Following microwave irradiation and post gravity drainage, the sludge was placed in a crown press and dewatered. The dewatered cake was analyzed for total solid. Compared to control samples that were not irradiated, the sludge percent solids in microwave irradiated sludge was increased at least 1.5%. The results are shown in FIG. 3.

### EXAMPLE 4

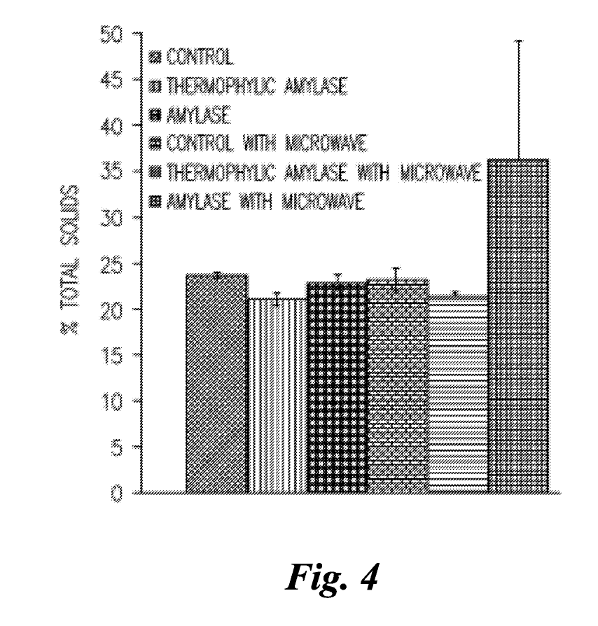

To 200 ml samples of non-irradiated sludge was added 3 μl of a solution of thermophylic amylase as obtained from the manufacturer (Genencor); 100 mg of amylase (non-thermophilic) (Sigma) was added to 1 L of non-irradiated sludge. The amylase-treated samples were allowed to react at 37° C. Following enzyme treatment, half of sludge samples from each treatment group were exposed to microwave irradiation, 30 ml at a time, as described in Example 1. All samples were then treated with flocculating polymer as described in Example 2, gravity drained and pressed and evaluated for percent total solids. The results are shown in FIG. 4.

Sludge samples that were treated with thermophilic amylase and exposed to microwave irradiation did not show improvement over control samples. On the other hand, sludge samples that were treated with non-thermophilic amylase and exposed to microwave irradiation showed an unexpectedly dramatic increase in the percent solids when compared to all other treatment groups, suggesting that the level of microwave irradiation does not raise the temperature sufficiently to exert a thermal effect on the improved dewaterability.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments without departing from their scope. While the dimensions and types of materials described herein are intended to define the parameters of the various embodiments, they are by no means limiting and are merely exemplary. Many other embodiments will be apparent to those of skill in the art upon reviewing the above description. The scope of the various embodiments should, therefore, be determined with reference to the appended claims, along with the full scope of equivalents to which such claims are entitled. It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

All publications, patents, and patent applications mentioned herein are hereby incorporated by reference in their entirety as if each individual publication or patent was specifically and individually indicated to be incorporated by reference. In case of conflict, the present application, including any definitions herein, will control. While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the disclosure may include only some of the described embodiments. Accordingly, the invention is not to be seen as limited by the foregoing description, but is only limited by the scope of the appended claims.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for treating sludge, the method comprising:
exposing the sludge to microwave irradiation, wherein an absorbed power density in the sludge is 7 W/ml to about 13 W/ml.

2. The method of claim 1, wherein the microwave irradiation is at an absorbed power density of about 10 W/ml.

3. The method of claim 1, wherein the microwaves are in the frequency range of about 0.4 GHz to about 6 GHz.

4. The method of claim 1, wherein the microwaves are in the frequency range of about 0.915 GHz to about 2.45 GHz.

5. The method of claim 1, wherein the sludge is exposed to the microwave irradiation for about 1 second to about 60 seconds.

6. The method of claim 1, wherein the sludge is exposed to the microwave irradiation for about 5 seconds to about 50 seconds.

7. The method of claim 1, wherein the sludge is exposed to the microwave irradiation for about 10 seconds to about 30 seconds.

8. The method of claim 1, wherein an enzyme is mixed with the sludge prior to microwave irradiation exposure.

9. The method of claim 1, wherein a flocculating agent is mixed with the sludge following microwave irradiation.

10. The method of claim 1, further comprising subjecting the sludge to dewatering by mechanical means.

11. The method of claim 1, wherein the sludge is biological sludge.

12. The method of claim 9, wherein the enzyme is amylase.

13. The method of claim 1, wherein the microwave irradiation is applied as continuous wave irradiation.

14. A method for dewatering sludge, the method comprising substantially sequentially:
a) adding a predetermined amount of an enzyme composition comprising a glucosidic polysaccharide hydrolyzing activity to form an enzyme-treated sludge;
b) exposing the enzyme-treated sludge to microwave irradiation, wherein an absorbed power density in the sludge is 7 W/ml to about 13 W/ml; and
c) exposing the irradiated sludge to mechanical dewatering.

15. The method of claim 14, wherein the microwave irradiation is at an absorbed power density of about 10 W/ml.

16. The method of claim 14, wherein the sludge is exposed to microwave irradiation for about 1 second to 50 seconds.

17. The method of claim 14, wherein the sludge is exposed to microwave irradiation for about 5 seconds to 40 seconds.

18. The method of claim 14, wherein the sludge is exposed to microwave irradiation for about 10 seconds to about 30 seconds.
